(19) United States
(12) Patent Application Publication
(10) Pub. No.: US 2023/0250859 A1
(43) Pub. Date: Aug. 10, 2023

(54) VIBRATION ISOLATOR

(71) Applicant: MARCO Systemanalyse und Entwicklung GmbH, Dachau (DE)

(72) Inventor: Martin Reuter, Dachau (DE)

(21) Appl. No.: 18/100,633

(22) Filed: Jan. 24, 2023

(30) Foreign Application Priority Data
Jan. 25, 2022 (DE) 102022101722.2

(51) Int. Cl. F16F 15/023; F16F 15/027; B25J 19/00

(52) U.S. Cl. CPC F16F 15/0232; F16F 15/027; B25J 19/0091; F16F 2230/08; F16F 2230/14

(57) ABSTRACT

A vibration isolator has a bearing body that is supported on at least two air springs, wherein each air spring has a chamber which is closed by a membrane and to which compressed air can be applied.

The present invention relates to a vibration isolator comprising a bearing body and air springs that have a chamber closed by a membrane.

Vibration isolators are known from the prior art that have a membrane that divides an air space into two chambers communicating with one another via a connection. The air pressure under the membrane can be set via a pressure regulating valve such that a vibration isolation takes place. In some applications, three air springs are used to support the load. Systems are also known in which the load is supported by more air springs.

In machines in which a mass is moved, a possible movement should be intercepted in all six degrees of freedom. For this purpose, additional position regulators are used in the prior art that fix the mass in the plane. At least three position regulators, for example horizontally operating dual-acting cylinders, are in turn required for this purpose.

When using robots for metering very small quantities with the aid of jet valves, a comparatively heavy head of the robot moves to any desired location of the working space in any desired direction. On the other hand, such robots or metering systems are not very large so that conventional vibration isolators cannot be used.

It is therefore the object of the present invention to provide a vibration isolator that is compact in design and that provides an optimized vibration isolation.

This object is satisfied by the features of claim 1 and in particular by a vibration isolator that comprises a bearing body that is supported on at least two air springs, wherein each air spring has a chamber which is closed by a membrane and to which compressed air can be applied via a controllable valve. Furthermore, each membrane is arranged in a plane in its position of rest, wherein the two planes are arranged or oriented in a V shape with respect to one another and the bearing body is disposed on the two air springs.

In accordance with the invention, the bearing body is thus arranged between two air springs inclined toward one another. The membrane of each air spring is arranged in a plane in its position of rest, i.e. in its undeflected position, that is, the membrane is planar in shape in its undeflected position, i.e. it is not (at least partly) corrugated or rolled, as is known from the prior art. Thus, a V-shaped arrangement can be implemented in which each membrane lies in a planar manner in a plane and forms one leg of the V.

In accordance with the invention, gravity is used for all of the possible movement axes, i.e. no actuators are used horizontally. Since, in accordance with the invention, no horizontally or vertically acting or arranged air springs are used, air springs can be used for compensation in all the degrees of freedom. In accordance with the invention, the direction of action of each air spring is neither horizontally nor vertically oriented in its assembly position. Rather, it extends at an acute angle between, for example, approximately 10° to approximately 60° relative to the perpendicular.

The vibration isolator described above can be manufactured in a very compact design and systems that, for example, comprise three or four vibration isolators of the above-described kind can be assembled with such vibration isolators. In the case of three vibration isolators, they can be arranged in a star shape under the mass to be isolated. In the case of the support on a total of four vibration isolators, a kinematic overdetermination indeed results. However, it can be reliably compensated with the aid of an electronic control. In both cases, an apparatus to be isolated is isolated from vibrations in all six degrees of freedom. Thus, an arrangement comprising exactly three vibration isolators in accordance with the invention so-to-say represents a hexapod whose actuators (the membranes) are controlled such that the base of the hexapod remains as unmoved as possible.

Advantageous embodiments of the invention are described in the description, in the drawing, and in the dependent claims.

In a first advantageous embodiment, the lines of action of the two air springs can intersect at an acute angle. In this respect, the line of action of an air spring is understood as a normal to the center of gravity of the air spring, i.e. a straight line along which the spring force develops in the region of the center of gravity of the spring.

In accordance with a further advantageous embodiment, the bearing body can be supported on the air springs via ball bearings. The friction in the region of the boundary surface between the bearing body and the air spring is hereby greatly reduced, which promotes a vibration isolation. In accordance with a further advantageous embodiment, the ball bearing can be configured as an areal ball bearing, for example, by providing a planar ball cage to accommodate the individual balls of the ball bearing. In this embodiment, a very advantageous decoupling between a plurality of vibration isolators results since one vibration isolator can compensate a movement with respect to two degrees of freedom. The remaining four degrees of freedom can then be considered by two further vibration isolators in accordance with the invention since the two areal ball bearings of the first vibration isolator enable a free movement along two times two further axes.

In accordance with a further advantageous embodiment, the ball bearing or the ball cage can be centered and held in the vibration isolator by spring clips. It is hereby possible to clip in the ball bearing between the spring clips, which promotes a simple and fast assembly.

In accordance with a further advantageous embodiment, the bearing body can have two support surfaces that are inclined at approximately the same angle to one another as the two planes in which each membrane is located in its position of rest. In this case, the air springs and the respective support surfaces of the bearing body form two parallel planes so that the bearing body can be accommodated in a space-saving manner between the two membranes.

In accordance with a further advantageous embodiment, each membrane can be provided with a bearing plate that is, for example, screwed to the membrane. The bearing body or a ball bearing arrangement can then be arranged on the bearing plate, whereby a low-friction support results in both cases.

In accordance with a further advantageous embodiment, at least one abutment can be provided for the bearing body to form a mechanical vibration limit. In this respect, at least one abutment can be configured as a damper or can have a damper. For example, an abutment can have a rubber-like element. It is also possible to provide an abutment at the upper side of the bearing body so that said abutment cannot fall off from the vibration isolator during the transport of the vibration isolator. At the same time, this embodiment offers the advantage that the bearing body can be set against the abutment at the upper side of the bearing body for calibration purposes. In this position, the bearing body has a unique predefined position that can be used for control and regulation purposes.

In accordance with a further advantageous embodiment, the two planes can be inclined at an angle of approximately 90° to 150° to one another. Good results have hereby been achieved in initial trials.

In accordance with a further advantageous embodiment, a pressure regulating valve can be provided for each chamber, said pressure regulating valve in each case being controlled by a vibration sensor that detects a vibration of the membrane. Due to an electronic control, a movement of the membrane can be determined with the aid of the vibration sensor and, depending on this movement, the associated pressure regulating valve can be controlled so that the pressure in the chamber beneath the membrane is either increased or reduced. The vibration sensor can be configured as a distance sensor by which the membrane can be regulated to a constant position.

In accordance with a further embodiment, the bearing body (and thus also the mass to be isolated from vibrations) can be disposed on exactly two air springs that are in particular arranged in a common housing. In an embodiment with exactly two air springs, a compact unit is present that can be placed at three or four positions beneath a machine bearing, depending on requirements. To regulate the position of a body in space, it is known to regulate six directions of movement with one actuator each. In accordance with the invention, a minimum of three vibration isolators comprising two active air springs are provided in one housing.

In a system comprising four vibration isolators, each having exactly two air springs, the vibration isolators can, for example, be arranged along two axes intersecting at right angles, whereby an overdetermination is indeed present, but a vibration decoupling along all six degrees of freedom is in turn possible. The overdetermination can be resolved in that it is defined that one vibration isolator serves as the master that is followed by the other vibration isolators with the pressure regulation as the slave.

The present invention will be described in the following with reference to an exemplary embodiment and to the drawings. There are shown:

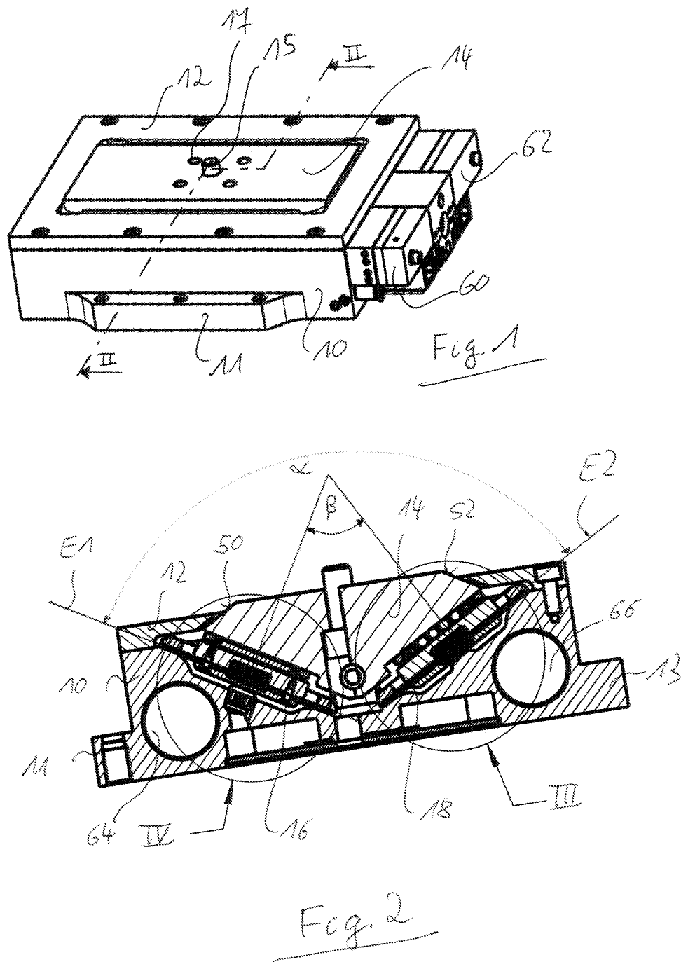

FIG. 1 a perspective view of a vibration isolator;

FIG. 2 a sectional view through the vibration isolator of FIG. 1 along the line II-II;

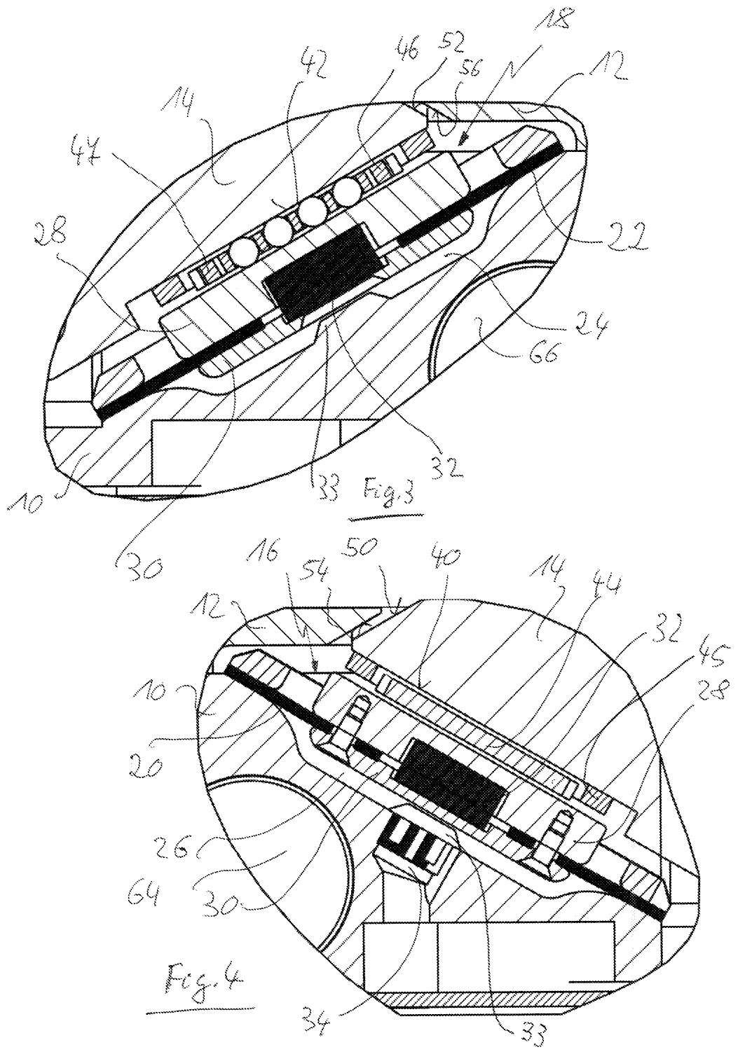

FIG. 3 an enlarged part representation of the region III of FIG. 2;

FIG. 4 an enlarged part representation of the region IV of FIG. 2;

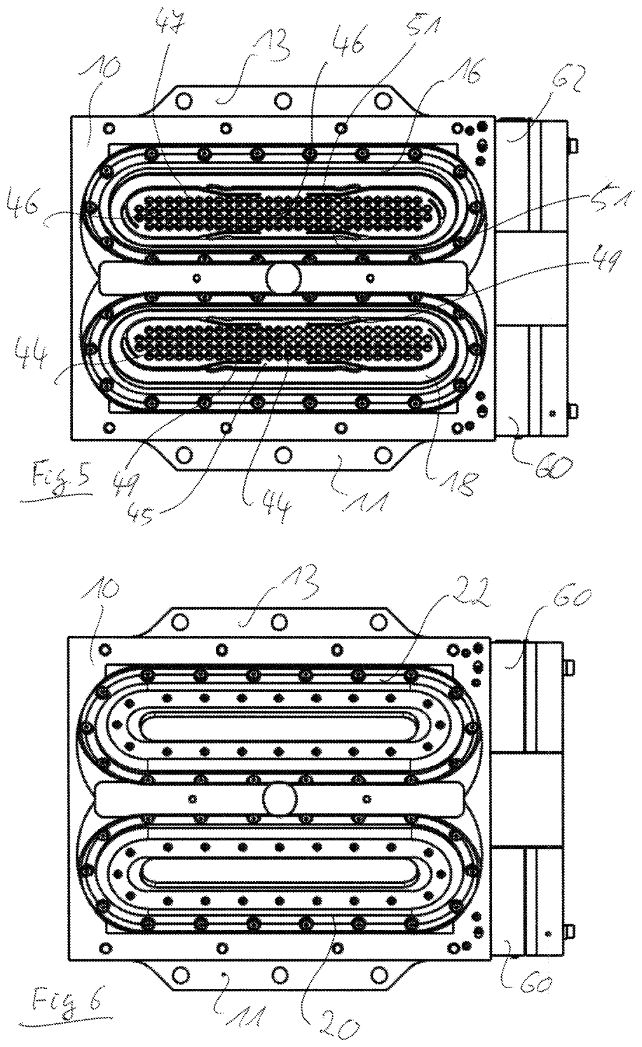

FIG. 5 a plan view of the vibration isolator of FIG. 1 with the cover removed and the bearing body removed;

FIG. 6 a plan view of the arrangement of FIG. 5 with the bearing balls removed;

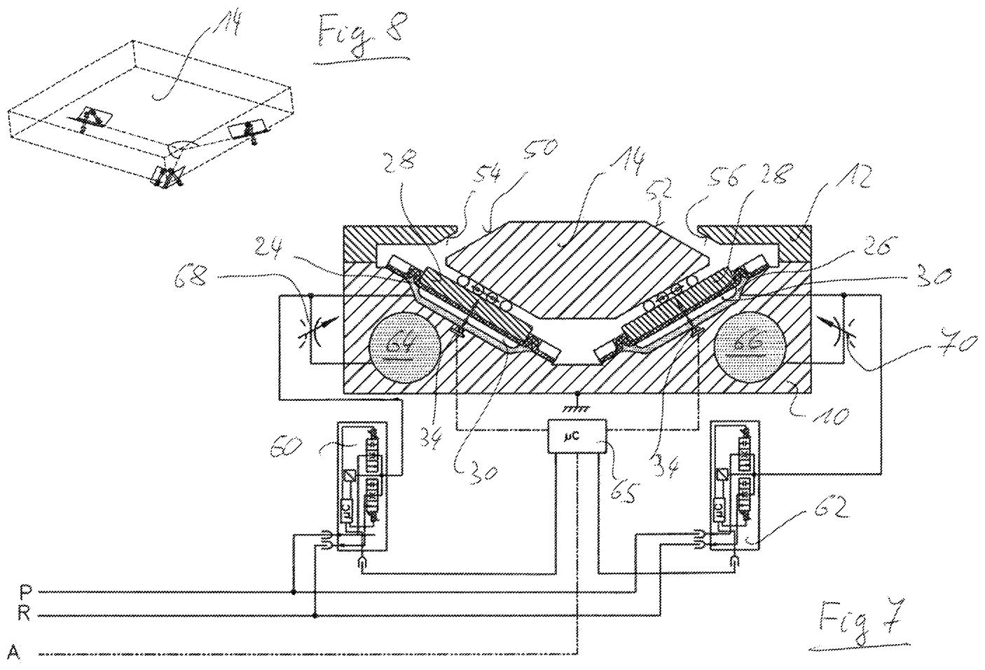

FIG. 7 a connection diagram of a vibration isolator; and

FIG. 8 a system with three vibration isolators in accordance with FIGS. 1 to 7.

FIG. 1 shows, in a perspective representation, a vibration isolator with a base housing 10 that is closed at its upper side by a frame-shaped cover 12. In the base housing 10, a bearing body 14 is supported on two air springs 16, 18 that are likewise received in the base housing 10.

In this embodiment, both air springs 16 and 18 are of the same design. As FIG. 3 and FIG. 4 illustrate, each air spring 16, 18 has a membrane 20, 22 that is in each case attached above a chamber 24, 26 and seals it tightly. Each chamber 24 and 26 can have compressed air applied to it via a respective pressure regulating valve 60, 62, i.e. can be ventilated and vented, for which purpose the two valves 60, 62 are controlled via a microcontroller 65 (FIG. 7). The respective air supply into the chambers 24 and 26 is not shown in the Figures. Pressure sensors that measure the pressure in each chamber and that are in communication with the microcontroller 65 are likewise not shown. Such pressure sensors can, for example, be integrated into the pressure regulating valves.

FIGS. 2 to 4 show each membrane 20, 22 in its position of rest, i.e. in its undeflected position. In this position of rest, each membrane 20, 22 is arranged in a plane, i.e. the membrane is planar in shape, wherein the two planes in which the two membranes are arranged in their position of rest are arranged or oriented in a V shape with respect to one another. In other words, the two membranes lie on the legs of a V that has an opening angle α that amounts to approximately 120° in the embodiment shown. Accordingly, the lines of action of the two air springs 16 and 18 intersect at an acute angle β (cf. FIG. 2) that amounts to approximately 60° in the embodiment shown.

As in particular FIG. 3 and FIG. 4 show, each membrane 20, 22 is screwed to a bearing plate 28 that is held at the oppositely disposed side of the membrane by a counter-pressure plate 30. A rubber damper 32 is located in a hollow space between the bearing plates 28 and the counter-pressure plates 30 and cooperates with a fixed abutment 33 of the base housing 10 to dampen an abutting of the moving masses in extreme cases.

The bearing body 14 disposed on the two air springs 16 and 18 is approximately triangular in cross-section and has two support surfaces 40 and 42 at its lower side that are inclined at the same angle α to one another as the two planes E1 and E2. Between the bearing plates 28 of the air springs 16 and 18 and the two support surfaces 40 and 42, an areal ball bearing 44, 46 is in each case provided that, in the embodiment shown, has a racetrack-shaped peripheral contour and that has a plurality of bearing balls that are arranged distributed over the bearing plate 28 with the aid of an areal ball cage 45, 47.

FIG. 5 shows a plan view of the base housing 10 with the cover 12 removed and the bearing body 14 removed. As can be seen, the two air springs 16 and 18 are disposed in parallel next to one another, wherein the ball bearings 46 and 48 are placed above the bearing plates 28. The two ball bearings 44 and 46 are centered and held in their position with the aid of spring clips 49, 51 in each case. FIG. 6 shows the view of FIG. 5 with the ball bearings 44 and 46 removed so that the membranes 20, 22 are visible.

As FIG. 2 shows, the bearing body 14 is provided, at its upper side, with two chamfers 50, 52 that extend in parallel with corresponding chamfers 54, 56 in the opening of the cover 12. The two chamfers 54 and 56 of the cover 12 hereby form an upper fixed abutment for the bearing body 14 that simultaneously prevents that the bearing body 14 can fall out of the housing 12 when the cover is closed. Below the two membranes 20, 22, the abutment 33 is provided which the damper 32 can abut to prevent too hard an impacting of the bearing body 14 during extreme vibrations.

FIG. 1 illustrates that the two pressure regulating valves 60 and 62 are laterally arranged at the base housing 10 and are fastened there. Electrical and pneumatic connectors are located beneath the two pressure regulating valves 60 and 62. Furthermore, two damping chambers 64 and 66 are provided in the base housing 10 and are in communication with one of the chambers 24, 26 via an adjustable throttle valve 68, 70 in each case.

The vibration isolator described above can easily be mounted on a horizontal base surface using fastening flanges 11 and 13 provided at the side of the base housing 10. A device to be isolated from vibrations, for example a metering robot or another apparatus, can then be connected to the bearing body 14, wherein, for a facilitated assembly at the center of the bearing body 14, a centering pin 15, which is surrounded by threaded bores 17, is provided at the upper side of said bearing body 14.

As has already been mentioned above, a plurality of the vibration isolators described above can be provided under a device to be isolated from vibrations, wherein, in the case of three vibration isolators, a star-shaped arrangement shown in FIG. 8 is advantageous to isolate vibrations in all six degrees of freedom. In the arrangement shown, exactly three vibration isolators in accordance with the invention are positioned under a base plate spaced as far apart as possible from one another in a star-shaped arrangement.

To be able to detect the vibration of each membrane 16, 18, a vibration sensor 34 in the form of a sensor coil, which detects a movement of the counter-pressure plate 30 that consists of or includes iron, is integrated in the base housing 10 at the base of each chamber 24, 26. The two vibration sensors 34 determine a change in the distance between the sensor coil and the membrane and are in communication with the microcontroller 65 (FIG. 7) and control the two pressure regulating valves 60, 62 so that the two chambers 24, 26 have a predetermined pressure applied to them or are also relieved of pressure. Accordingly, the two pressure regulating valves 60 and 62 are connected to a pressure line P and a return line R. The reference character A designates a data line and a power supply line.

For an unregulated operation for vibration isolation, the two chambers 24 and 26 can first have a pressure applied to them so that the bearing body 14 contacts the abutments 54, 56 such that the bearing body 14 adopts a predetermined position and a defined position. The pressure in the chambers can subsequently be reduced so that both membranes adopt their position of rest shown in the Figures. A higher-frequency vibration isolation can then take place in that the fluid in the chambers (usually air) flows into and out of the damping chambers 64 and 66 via the respective damping valve 68 and 70.

However, if an active vibration damping is desired, the sensors 34 can detect a movement of each membrane and the microcontroller 65 can then control the pressure regulating valves 60 and 62 such that the vibration of each membrane is damped by regulating the pressure in the chambers 24 and 26.

A particularly advantageous procedure for vibration isolation results when the resulting vibrations are known in advance, for example, since a robot or another machine moves along a predefined movement profile. Of course, a robot is mentioned here only as an example of an apparatus that generates vibrations during operation. To perform the method, the machine or the robot can be fastened to the bearing body of a vibration isolator described above and is then moved in accordance with a predefined movement profile. For example, a metering robot can be moved such that a metering valve is moved along a predefined movement path. The vibrations occurring here can be detected and recorded with the aid of a vibration sensor, wherein, for example, the distance sensors 34 of the vibration isolator can be used. Optionally, a deviation from a distance adjusted by a pressure application is determined for each membrane.

When the machine or the robot is subsequently moved along the predefined movement profile again, the vibrations that occur in this process are already known and a previously created pressure profile for the pressure in each chamber can be used to counteract the vibrations that occur during the movement. For this purpose, the two chambers 24, 26 can have a pressure applied to them such that the pressure corresponds to the created pressure profile when the robot or the machine is again moved in accordance with the predefined movement profile. An exceptional vibration compensation can hereby be achieved. In this connection, it can also be advantageous to trigger the pressure variations somewhat ahead of time in order to consider reaction times of the pressure regulating valves.

Real-time Ethernet applications (RTE), in particular in connection with Power over Ethernet (PoE), are suitable for a fast data acquisition of the movement data of the robot and of the data of the vibration sensor.

1.-15. (canceled)

16. A vibration isolator, comprising
a bearing body that is supported on at least two air springs, wherein each air spring has a chamber which is closed by a membrane and to which compressed air can be applied via a controllable valve, wherein
each membrane is arranged in a plane in its position of rest,
the two planes are arranged in a V shape with respect to one another, and
the bearing body is disposed on the two air springs.

17. The vibration isolator in accordance with claim 16,
wherein the lines of action of the two air springs intersect at an acute angle.

18. The vibration isolator in accordance with claim 16,
wherein the bearing body is supported on the air springs via an areal ball bearing in each case.

19. The vibration isolator in accordance with claim 16,
wherein a ball bearing whose balls are held in a spring-centered ball cage is provided between the bearing body and each air spring.

20. The vibration isolator in accordance with claim 16,
wherein each membrane is provided with a bearing plate.

21. The vibration isolator in accordance with claim 16,
wherein at least one abutment is provided for the bearing body.

22. The vibration isolator in accordance with claim 21,
wherein at least one abutment of said at least one abutments is configured as a damper or has a damper.

23. The vibration isolator in accordance with claim 16,
wherein the bearing body has two support surfaces that are inclined at the same angle to one another as the two planes.

24. The vibration isolator in accordance with claim 16,
wherein the two planes are inclined at an angle of approximately 90°-150° to one another.

25. The vibration isolator in accordance with claim 16,
wherein a pressure regulating valve is provided for each chamber, said pressure regulating valve in each case being controlled by a vibration sensor that detects a vibration of the membrane.

26. The vibration isolator in accordance with claim 16,
wherein the bearing body is disposed on exactly two air springs.

27. The vibration isolator in accordance with claim 26,
wherein the two air springs are arranged in a common housing.

28. A system for vibration isolation, comprising three or four vibration isolators, the vibration isolators comprising a bearing body that is supported on two air springs, wherein each air spring has a chamber which is closed by a membrane and to which compressed air can be applied via a controllable valve, wherein each membrane is arranged in a plane in its position of rest, the two planes are arranged in a V shape with respect to one another, the bearing body is disposed on the two air springs, and each vibration isolator having exactly two air springs.

29. A method for the vibration isolation of a robot using at least one vibration isolator, the vibration isolator comprising a bearing body that is supported on at least two air springs, wherein each air spring has a chamber which is closed by a membrane and to which compressed air can be applied via a controllable valve, wherein each membrane is arranged in a plane in its position of rest, the two planes are arranged in a V shape with respect to one another, and the bearing body is disposed on the two air springs, said method comprising the following steps:
fastening a robot to the bearing body;
moving the robot in accordance with a predefined movement profile;
detecting the vibrations occurring in this process with the aid of a vibration sensor;
creating a pressure profile for the pressure in each chamber such that the occurring vibrations are counteracted when the robot is moved in accordance with the predefined movement profile; and profile when the robot is again moved in accordance with the predefined movement profile.

30. The method in accordance with claim 29,
wherein the vibrations are detected by a distance sensor of the vibration isolator.

31. The method in accordance with claim 30,
wherein a deviation from a distance adjusted by the pressure application is determined for each membrane.

32. The method in accordance with claim 29,
wherein the chambers have a predetermined pressure applied to them before the detection of the vibrations.

33. The method in accordance with claim 32,
wherein said predetermined pressure is selected such that each membrane is in its position of rest.
